(19) United States
(12) Patent Application Publication
(10) Pub. No.: US 2014/0239932 A1
(43) Pub. Date: Aug. 28, 2014

(54) DETERMINING A CHARACTERISTIC OF A SIGNAL IN RESPONSE TO A CHARGE ON A CAPACITOR

(71) Applicant: INTERSIL AMERICAS LLC, Milpitas, CA (US)

(72) Inventor: Martin GALINSKI, Santa Clara, CA (US)

(73) Assignee: INTERSIL AMERICAS LLC, Milpitas, CA (US)

(21) Appl. No.: 13/829,555

(22) Filed: Mar. 14, 2013

Related U.S. Application Data
(60) Provisional application No. 61/769,404, filed on Feb. 26, 2013.

(51) Int. Cl. G05F 1/565

(52) U.S. Cl. CPC G05F 1/565
USPC 323/285

(57) ABSTRACT

In an embodiment, an apparatus includes a charging circuit and a determining circuit. The charging circuit is configured to generate a charge on a capacitor with a first current that is related to a signal having a characteristic, and the determining circuit is configured to determine the characteristic of the signal in response to the charge on the capacitor. For example, such an apparatus can determine an average of an input current to a power supply, or an average of an output current from a power source for the power supply, by mirroring the input current, charging a capacitor with the mirroring current, and determining the voltage across the charged capacitor.

### PRIORITY CLAIM

This application claims priority from provisional patent application No. 61/769,404 filed Feb. 26, 2013, which is incorporated in its entirety herein by reference.

### SUMMARY

In an embodiment, an apparatus, such as a power-supply controller, includes a charging circuit and a determining circuit. The charging circuit is configured to generate a charge on a capacitor with a first current that is related to a signal having a characteristic, and the determining circuit is configured to determine the characteristic of the signal in response to the charge on the capacitor.

For example, an embodiment of such an apparatus may be able to determine an average of an input current to a power supply, or an average of an output current from a power source for the power supply, by mirroring the input current and charging a capacitor with the mirroring current. To determine the average of the input current, the capacitor effectively integrates the input current over the power-supply switching period, and the current mirror and the capacitor may be designed such that the magnitude of a voltage across the capacitor approximately equals the magnitude of the average input current. To determine the average of the power-source output current, the power-supply controller effectively filters the voltage across the capacitor with an impedance that approximately equals the impedance between the power source and the input node of the power supply.

### BRIEF DESCRIPTION OF THE DRAWINGS

FIG. 1 is a diagram of a power system that includes a power source, a power supply that receives power form the power source, and a load that receives power form the power supply, according to an embodiment.

FIG. 2 is a time plot of the input current to the power supply of FIG. 1, according to an embodiment.

FIG. 3 is a diagram of a power system that includes a power source, a power supply that receives power form the power source, and a load that receives power form the power supply, according to another embodiment.

FIG. 4 is a time plot of the voltage across the integrating capacitor of FIG. 3, where the voltage represents the average input current to the power supply of FIG. 3, according to an embodiment.

FIG. 5A is a time plot of the input current to the power supply of FIG. 3, according to an embodiment.

FIG. 5B is a time plot of the average of the input current to the power supply of FIG. 3, and of the average output current from the power source of FIG. 3, according to an embodiment.

FIG. 6A is a time plot of the average output current from a power source to a power supply while the power supply is operating in a current-limiting mode using a conventional technique for determining the average input current to the power supply, according to an embodiment.

FIG. 6B is a time plot of the average output current from a power sourced to a power supply while the power supply is operating in a current-limiting mode using the technique described in conjunction with FIGS. 3 and 4 for determining the average input current to the power supply, according to an embodiment.

FIG. 7 is a diagram of a system that incorporates the power system or power supply of FIG. 3, according to an embodiment.

### DETAILED DESCRIPTION

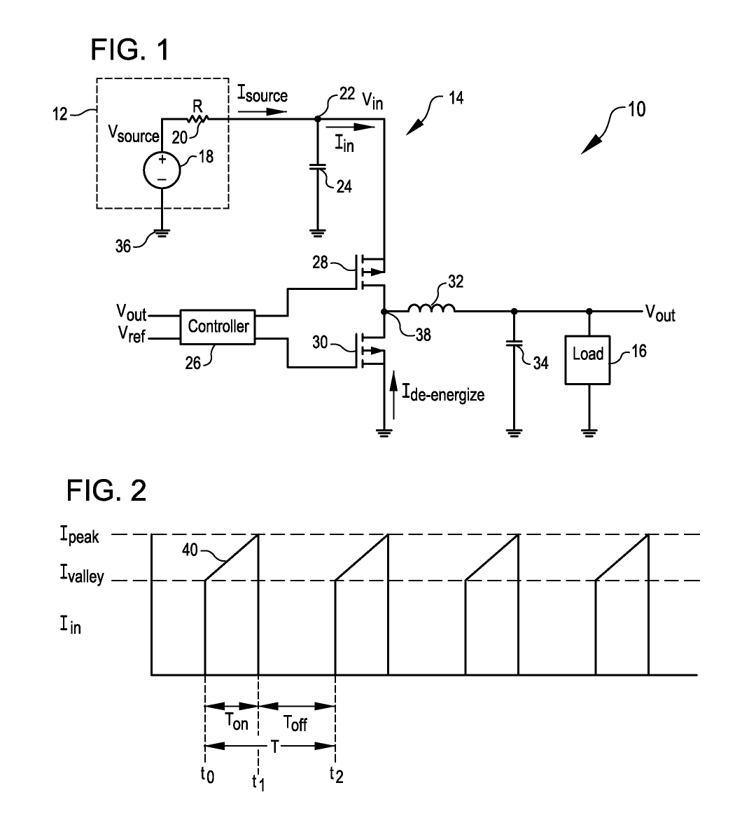

FIG. 1 is a schematic diagram of a power system 10, which includes a power source 12, a power supply (here a buck converter) 14, and a load 16, according to an embodiment. The power supply 14 converts an input voltage Vᵢₙ from the power source 12 into a regulated output voltage Vₒᵤₜ, which powers the load 16. Where, as in the described embodiment, the power supply 14 is a buck converter, |Vₒᵤₜ|<|Vᵢₙ|; for example, Vᵢₙ=5 Volts (V) and Vₒᵤₜ=1.3 V.

The power source 12 may be modeled as including an ideal DC voltage source 18 and an internal impedance 20. The ideal voltage source 18 is configured to generate a voltage V_{source} and to provide an output current I_{source}, and the impedance 20 has a value of R—although the impedance is described has having only a real impedance value R, it may have a complex value. Therefore, if R>0 and I_{source}>0, then Vᵢₙ<V_{source} due to the voltage drop across the impedance 20.

The buck-converter power supply 14 includes an input node 22, a power-source bypass capacitor 24, a switching controller 26, high-side and low-side switching transistors 28 and 30, a filter inductor 32, and a filter capacitor 34.

The bypass capacitor 24 prevents voltage oscillations and voltage ringing at the input node 22 by providing a low-impedance path to ground 36 for all non-zero-frequency signals at the input node.

The switching controller 26 controls the timing of the switching of the transistors 28 and 30 in response to Vₒᵤₜ, or in response to a feedback signal that is related to Vₒᵤₜ, in a manner that maintains Vₒᵤₜ at a voltage level that is set by a reference voltage V_{ref}.

The high-side transistor 28, when activated by the controller 26, couples the inductor 32 to the input node 22 such that a current Iᵢₙ (described below in conjunction with FIG. 2) flows from the input node, through the transistor 28 and the inductor (the low-side transistor 30 is inactive while the high-side transistor is active), and to the filter capacitor 34 and the load 16, thereby energizing the inductor. Iᵢₙ may not equal I_{source} due to the presence of the network formed by the source impedance 20 and the bypass capacitor 24.

The low-side transistor 30, when activated by the controller 26, couples the inductor 32 to ground 36 such that a current I_{de-energize} flows from ground, through the low-side transistor and the inductor (the high-side transistor 28 is inactive while the low-side transistor is active), and to the filter capacitor 34 and the load 16, thereby de-energizing the inductor. As described below in conjunction with FIG. 2, the current I_{de-energize} typically does not decay all the way to zero before the controller 26 again activates the high-side transistor 28 to repeat the above-described cycle.

The switching of the transistors 28 and 30 generates, at an intermediate node 38 between the transistors, a digital-like voltage that transitions between two levels, approximately Vᵢₙ and ground.

But the inductor 32 and the capacitor 34 effectively filter the voltage at the intermediate node 38 to generate the regulated DC output voltage Vₒᵤₜ.

Furthermore, the load 16 may be any suitable load, such as a microprocessor, a microcontroller, or a memory.

FIG. 2 is a time plot of the input current Iᵢₙ of FIG. 1, according to an embodiment. The input current Iᵢₙ has a period of T, which is equal to 1/F, where F is the frequency at which the controller 26 switches the transistors 28 and 30; that is, F is the switching frequency of the power supply 14. Furthermore, the current Iᵢₙ linearly increases from I_{valley} to Iₚₑₐₖ during a portion Tₒₙ of the period T; Tₒₙ corresponds to the time during which the high-side transistor 28 is active and the low-side transistor 30 is inactive. Moreover, Iᵢₙ is zero during a portion T_{off} of the period T; T_{off} corresponds to the time during which the high-side transistor 28 is inactive and the low-side transistor 30 is active. In addition, I_{de-energize} is zero during Tₒₙ, and decays linearly from Iₚₑₐₖ to I_{valley} during T_{off}; that is, while Iᵢₙ is non-zero, I_{de-energize} is zero, and while Iᵢₙ is zero, I_{de-energize} is non-zero. And the duty cycle D of the power supply 14 equals Tₒₙ/T.

Referring to FIGS. 1 and 2, the operation of the power system 10 of FIG. 1 is described, according to an embodiment.

At a time t₀, the controller 26 activates the high-side transistor 28 and deactivates the low-side transistor 30 (the controller may deactivate the low-side transistor first to prevent a crow-bar current from simultaneously flowing through both transistors) such that the current Iᵢₙ flows from the node 22, through the high-side transistor and inductor 32, and to the capacitor 34 and load 16. Because the current through an inductor cannot change instantaneously, the value of Iᵢₙ at t₀ equals I_{valley}, which is the value of the de-energizing current I_{de-energize} (not shown in FIG. 2) that was flowing through the inductor 32 immediately prior to t₀.

During Tₒₙ between the time t₀ and a time t₁, the current Iᵢₙ increases linearly. The voltage V across an inductor and the current I through an inductor are related according to the following equations:

V=L(dI/dt) (1)

such that

dI/dt=V/L (2)

For the power-supply system 10, one can assume that during Tₒₙ, the voltage across the high-side transistor 28 is negligible such that the voltage V across the inductor 32 equals (Vᵢₙ−Vₒᵤₜ)/L, and such that:

dIᵢₙ/dt=(Vᵢₙ−Vₒᵤₜ)/L (3)

And because one can assume that during Tₒₙ, Vᵢₙ and Vₒᵤₜ are constant, dIᵢₙ/dt, which is the rate at which Iᵢₙ is increasing during Tₒₙ, is also a constant, such that Iᵢₙ increases according to a straight line 40 having a constant slope that is equal to (Vᵢₙ−Vₒᵤₜ)/L.

At the time t₁, the controller 26 activates the low-side transistor 30 and deactivates the high-side transistor 28 (the controller may deactivate the high-side transistor first to prevent a crow-bar current from simultaneously flowing through both transistors) such that the current I_{de-energize} flows from ground 36, through the low-side transistor and inductor 32, and to the capacitor 34 and load 16. Because the current through an inductor cannot change instantaneously, the value of I_{de-energize} at t₁ equals Iₚₑₐₖ, which is the value of the input current Iᵢₙ that was flowing through the inductor 32 immediately prior to t₁.

Further at the time t₁, the current Iᵢₙ falls rapidly to zero, and remains at zero until a time t₂, at which time the above-described cycle repeats. Also, between the times t₁ and t₂, I_{de-energize} (not shown in FIG. 2) decays linearly with a slope of (Vₒᵤₜ)/L (the voltage across the low-side transistor 30 can be assumed to be negligible such that the inductor 32 can be assumed to be coupled between Vₒᵤₜ and ground).

Still referring to FIGS. 1 and 2, alternate embodiments of the power system 50 are contemplated. For example, the power supply 14 may include one or more additional components not described above, or may omit one or more of the above-described components.

Furthermore, in some applications, one may wish to know the average of Iᵢₙ, i.e., Iᵢₙ_{_{—}}_{avg}, for each switching period T, the average of I_{source}, i.e., I_{source}_{_{—}}_{avg} for each switching period T, or both Iᵢₙ_{_{—}}_{avg} and I_{source}_{_{—}}_{avg} for each switching period T. For example, one may wish to limit Iᵢₙ_{_{—}}_{avg} to prevent damage to the power supply 14. Or, one may wish to limit I_{source}_{_{—}}_{avg} to prevent damage to the power source 12; for example, if the power source is a battery, then one may wish to limit I_{source}_{_{—}}_{avg} to prevent overheating or premature discharge of the power source.

One way to determine Iᵢₙ_{_{—}}_{avg} over a switching period T is to insert a sense resistor between the node 22 and the high-side transistor 28, and to low-pass filter this sense voltage to generate a resulting low-pass-filtered voltage that is proportional to Iᵢₙ_{_{—}}_{avg}.

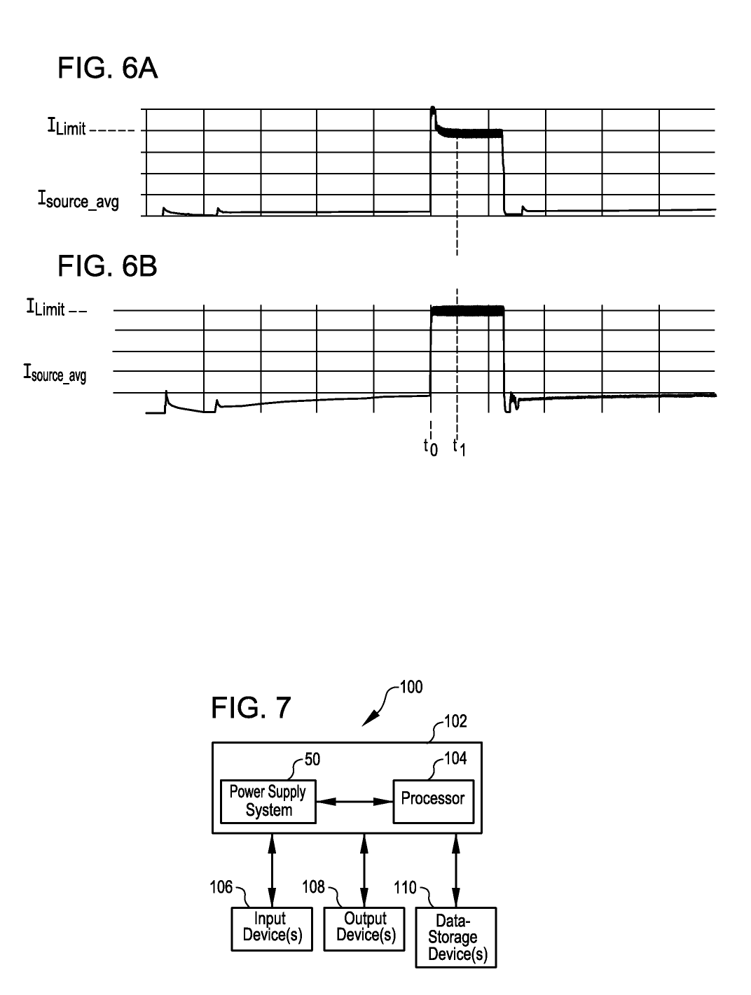

But there may be some problems with this approach. For example, the sense resistor may significantly decrease the efficiency of the power supply 14, and the resulting low-pass-filtered voltage may be significantly delayed relative to Iᵢₙ and Iᵢₙ_{_{—}}_{avg}; this delay may render a control loop or other circuitry for limiting Iᵢₙ_{_{—}}_{avg} too slow, as described below in conjunction with FIG. 6A.

Another way to determine Iᵢₙ_{_{—}}_{avg} over a switching period T is to use a processor to calculate Iᵢₙ_{_{—}}_{avg} according to the following equation:

$${I}_{i n \_ avg} = \frac{1}{T} {\int }_{0}^{T} {I}_{i n} d t \qquad ( 4 )$$

For example, for Iᵢₙ of FIG. 2, per equation (4), Iᵢₙ_{_{—}}_{avg} over a switching period T is given by the following equation:

Iᵢₙ_{_{—}}_{avg}=Tₒₙ/T(I_{valley}+Iₚₑₐₖ/2) (5)

But a problem with this approach is that it may require complex circuitry to measure, for example, I_{valley}, Iₚₑₐₖ, and Tₒₙ, and to calculate Iᵢₙ_{_{—}}_{avg} according to equation (4) or equation (5).

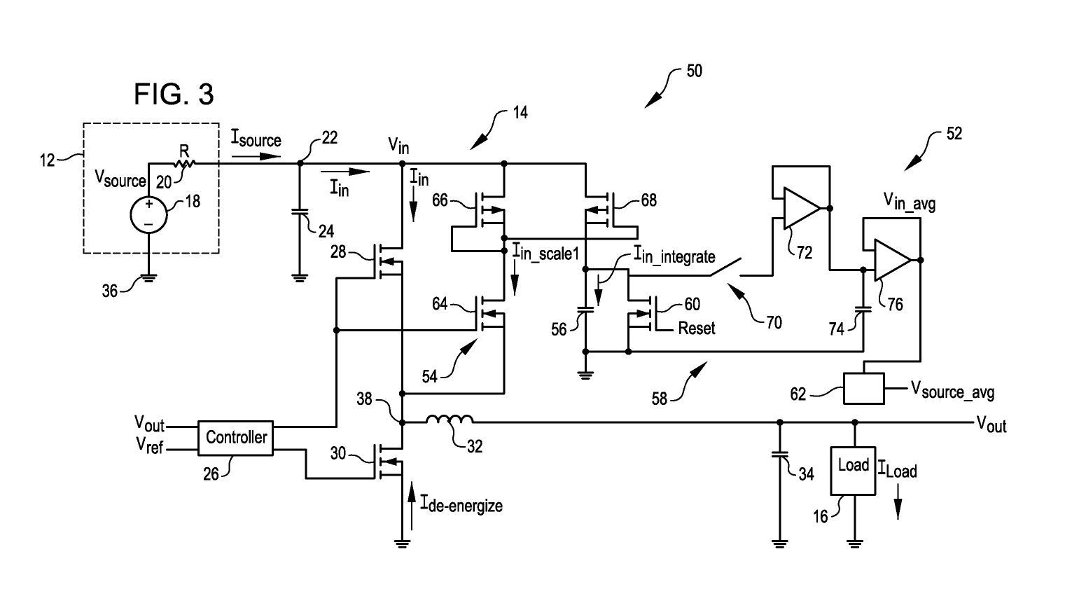

FIG. 3 is a diagram of a power system 50, which, in addition to the power source 12, power supply 14, and load 16, includes a determiner circuit 52 configured to determine Iᵢₙ_{_{—}}_{avg} and I_{source}, according to an embodiment, and like numbers are used to label components common to the power systems 10 (FIGS. 1) and 50; therefore, common components already described above in conjunction with FIGS. 1 and 2 are not described in conjunction with FIG. 3.

The determiner circuit 52 includes a current mirror 54, an integrating capacitor 56, a sample-and-hold circuit 58, a reset circuit 60, and a stage 62 effectively configured to determine I_{source} in response to Iᵢₙ_{_{—}}_{avg}.

The current mirror 54 includes transistors 64, 66, and 68.

The transistor 64 is an NMOS transistor configured to draw a current Iᵢₙ_{_{—}}_{scale1}, which is proportional to Iᵢₙ flowing through the high-side NMOS transistor 28 by a scaling factor S1. For example, S1 is less than unity, is related to the ratio of the channel widths of the transistors 28 and 64, and is selected such that Iᵢₙ_{_{—}}_{scale1} can be considered negligible so that one can assume that Iᵢₙ from the node 22 flows entirely through the high-side transistor 28 when the high-side transistor is active.

The transistor 66 is a PMOS transistor configured to conduct Iᵢₙ_{_{—}}_{scale1} from the transistor 64.

And the transistor 68 is a PMOS transistor configured to source a current Iᵢₙ_{_{—}}_{integrate}, which is proportional to Iᵢₙ_{_{—}}_{scale1} by a scaling factor S2. For example, S2 is less than unity, is related to the ratio of the channel widths of the transistors 66 and 68, and is selected such that Iᵢₙ_{_{—}}_{integrate} can be considered negligible so that one can assume that Iᵢₙ from the node 22 flows entirely through the high-side transistor 28 when the high-side transistor is active.

Therefore, Iᵢₙ_{_{—}}_{integrate} is given by the following equation:

Iᵢₙ_{_{—}}_{integrate}=Iᵢₙ×S1×S2 (6)

For example, the product of S1 and S1 may equal 1×10⁻⁶.

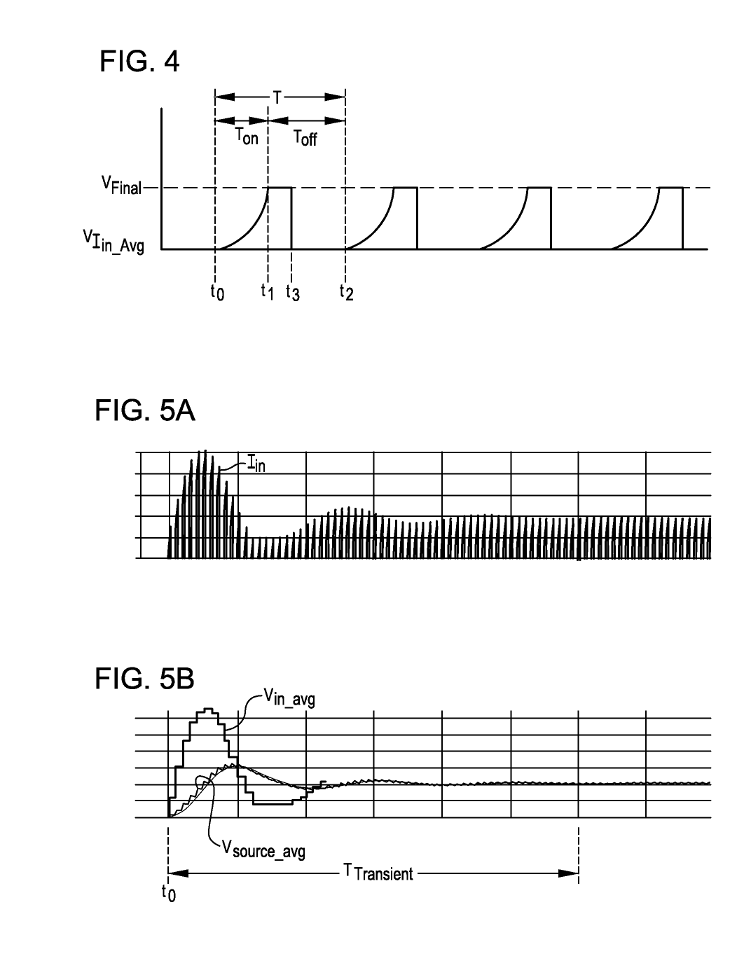

The integrating capacitor 56 receives, and effectively integrates, the current Iᵢₙ_{_{—}}_{integrate} from the transistor 68; that is, as described below, the magnitude of the charge stored on the integrating capacitor, and the magnitude of the voltage across this capacitor, are proportional to, and may be equal to, the magnitude of Iᵢₙ_{_{—}}_{avg}. That is, as described below in conjunction with FIG. 4, one can determine Iᵢₙ_{_{—}}_{avg} from the voltage across the integrating capacitor 56 at the end of each switching cycle of the power system 50.

The sample-and-hold circuit 58 samples and holds the voltage across the integrating capacitor 56 at the end of each switching cycle, and, after the sample-and-hold circuit samples and holds this capacitor voltage, the reset circuit 60 discharges the integrating capacitor to ready the integrating capacitor for the next switching cycle. The sample-and-hold circuit 58 includes a sample switch 70 (e.g., a transistor), a buffer 72, a hold capacitor 74, and another buffer 76, which generates a voltage V_{Iin}_{_{—}}_{avg}, which represents Iᵢₙ_{_{—}}_{avg}. And the reset circuit 60 includes an NMOS transistor.

The stage 62 is configured to generate I_{source}_{_{—}}_{avg} from the power source 12 in response to the voltage V_{Iin}_{_{—avg}}. For example, as described below in conjunction with FIGS. 3-5B, the stage 62 does this by effectively filtering V_{Iin}_{_{—}}_{avg} with approximately the same impedance as the impedance of the network between the node 22 and the ideal voltage source 18.

Before describing the operation of the power system 50, the theory behind the determiner circuit 52 is described.

The current I through, and the voltage V across, a capacitor C, are related according to the following equation:

I=C(dV/dt) (7)

And from equation (7), one can derive the following equation:

$$V = \frac{1}{C} \int I d t \qquad ( 8 )$$

Therefore, referring to FIGS. 2 and 3 and equations (6)-(8), V_{Iin}_{_{—}}_{avg} across the integrating capacitor 56 and the current Iᵢₙ are related by the following equation:

$${V}_{Iin \_ avg} = \frac{1}{C} {\int }_{0}^{T} {I}_{in \_ integrate} d t = \frac{1}{C} {\int }_{0}^{T} ( {I}_{i n} \cdot S 1 \cdot S 2 ) d t = \frac{S 1 \cdot S 2}{C} {\int }_{0}^{T} {I}_{i n} d t \qquad ( 9 )$$

And equation (9) yields the following equation:

$${V}_{Iin \_ avg} \cdot \frac{C}{S 1 \cdot S 2} = {\int }_{0}^{T} {I}_{i n} d t \qquad ( 10 )$$

Furthermore, equation (4) yields the following equation:

T·Iᵢₙ_{_{—avg}}=∫₀^{T}Iᵢₙdt (11)

Therefore, combining equations (10) and (11) yields the following equation:

$${V}_{Iin \_ avg} \cdot \frac{C}{S 1 \cdot S 2} = T \cdot {I}_{in \_ avg} \qquad ( 12 )$$

Ignoring the units of the terms in equation (12), setting the magnitude of V_{Iin}_{_{—}}_{avg} equal to the magnitude of Iᵢₙ_{_{—}}_{avg} yields the following equations for the value C of the integrating capacitor 56 in Farads:

C=|T·S1·S2| (13)

C=|(S1·S2)/F| (14)

Therefore, if one selects the value C of the integrating capacitor 56 per equation (13) or (14), then the magnitude of the voltage V_{Iin}_{_{—}}_{avg} that appears across the integrating capacitor, and that is output by the sample-and-hold circuit 58, at the end of a switching period equals the magnitude of the average input current Iᵢₙ_{_{—}}_{avg} over the same switching period.

FIG. 4 is a time plot of the voltage V_{Iin}_{_{—}}_{avg} across the integrating capacitor 56, and at the output of the sample-and-hold circuit 58, according to an embodiment.

Referring to FIGS. 3 and 4, the operation of the power system 50 is described, according to an embodiment. Because the operation of the power supply 14 is the same as described above in conjunction with FIGS. 1 and 2, only the operation of the determiner 52 is described in detail.

At the time t₀, the controller 26 activates the high-side transistor 28 such that the input current Iᵢₙ begins to flow through the high-side transistor as described above in conjunction with FIGS. 1 and 2—as described above, in this example Iᵢₙ_{_{—}}_{scale1} and Iᵢₙ_{_{—}}_{integrate} are small enough so that one can assume that Iᵢₙ flows from the node 22 through the high-side transistor.

In response to the current Iᵢₙ beginning to flow through the high-side transistor 28, the transistor 64 begins to generate Iᵢₙ_{_{—}}_{scale1}, in response to which the transistor 68 begins to generate Iᵢₙ_{_{—}}_{integrate}.

And Iᵢₙ_{_{—}}_{integrate} begins to charge, and, therefore, to develop a voltage across, the integrating capacitor 56.

During the portion Tₒₙ of the switching cycle between the times t₀ and t₁, Iᵢₙ increases linearly as shown in FIG. 2.

Therefore, because Iᵢₙ_{_{—}}_{integrate} mirrors Iᵢₙ, Iᵢₙ_{_{—}}_{integrate} also increases linearly between the times t₀ and t₁.

Per equation (8), because Iᵢₙ_{_{—}}_{integrate} increases linearly, V_{Iin}_{_{—}}_{avg} across the capacitor 56 increases parabolically; i.e., the wave form of V_{Iin}_{_{—}}_{avg} is a parabola.

At the time t₁, the controller 26 deactivates the high-side transistor 28 such that Iᵢₙ rapidly decreases to zero as described above in conjunction with FIGS. 1 and 2.

Also at the time t₁, the controller 26 deactivates the transistor 64 such that Iᵢₙ_{_{—}}_{scale1} and Iᵢₙ_{_{—}}_{integrate} also rapidly decrease to zero.

Consequently, at the time t₁, the voltage V_{Iin}_{_{—}}_{avg} across the integrating capacitor 56 stops increasing, and remains at an approximately constant level V_{final} due to the high impedances that the inactive transistor 68, open switch 70, and inactive reset circuit 60 present to the integrating capacitor.

At some point between the time t₁ and a time t₃, the controller 26 closes the switch 70 so as to charge, via the buffer 72, the hold capacitor 74 approximately to the voltage level V_{final} that exists across the integrating capacitor 56.

And, after the hold capacitor 74 is charged to approximately V_{final}, the controller 26 opens the switch 70.

Then, at the time t₃, the controller 26 activates the transistor of the refresh circuit 60 to discharge the integrating capacitor 56 in anticipation of the next switching cycle of the power system 50.

FIG. 5A is a time plot of the input current Iᵢₙ from the input node 22 of FIG. 3 in response to a step change in the load current I_{Load} through the load 16 of FIG. 3, according to an embodiment.

FIG. 5B is a time plot of Vᵢₙ_{_{—}}_{avg}, which represents the average input current Iᵢₙ_{_{—}}_{avg}, and of V_{source}_{_{—}}_{avg}, which represents the average source current I_{source}_{_{—}}_{avg} from the power source 12 of FIG. 3, in response to a step change in the load current I_{Load}, according to an embodiment. Both Vᵢₙ_{_{—}}_{avg} and V_{source}_{_{—}}_{avg} are shown on a cycle-by-cycle basis.

Referring to FIGS. 3, 5A, and 5B, the operation of the stage 62 of the determiner circuit 52 is described, according to an embodiment.

As described above, the stage 62 generates a voltage V_{source}_{_{—}}_{avg} having a magnitude and phase that are approximately proportional to, or that are approximately equal to, the magnitude and phase of I_{source}_{_{—}}_{avg}.

Before the time t₀, assume that the bypass capacitor 24 is charged to Vᵢₙ, and that because Iᵢₙ=0, Vᵢₙ=V_{source}.

Before or at the time t₀, a step increase in the load current I_{Load} occurs, and the network formed, at least in part, by the inductor 32 and the capacitor 34, causes the current through the inductor to “ring” during a transient-response period Tₜᵣₐₙₛᵢₑₙₜ.

At the time t₀, the controller 26 activates the high-side transistor 28, which effectively couples this ringing to the node 22, and, therefore, causes Iᵢₙ to ring as shown in FIG. 5A.

Because an impedance network formed primarily by the internal impedance 20 of the power source 12 and the bypass capacitor 24 is effectively disposed between the node 22 and the ideal voltage source 18, I_{source} equals Iᵢₙ as modified, or filtered, by this impedance network; that is, one can consider Iᵢₙ an input to this network, and I_{source} as an output of this network.

As described above, in an embodiment, the magnitude of V_{Iin}_{_{—}}_{avg} approximately equals the magnitude of Iᵢₙ_{_{—}}_{avg} on a cycle-by-cycle basis.

Therefore, if one inputs V_{Iin}_{_{—}}_{avg} to a filter having the same transfer function as that of the network formed by the internal resistance 20 and the bypass capacitor 24, then the output V_{source}_{_{—}}_{avg} of this filter has a magnitude and a phase that are approximately equal to the magnitude and the phase of I_{source}_{_{—}}_{avg}.

Consequently, the stage 62 may include a filter that is the same as the network formed by the resistance 20 and the bypass capacitor 24, or that may be topologically different (or that may be implemented digitally) but that has the same transfer function as this network, such that the magnitude of V_{source}_{_{—}}_{avg} is approximately proportional or approximately equal to the magnitude of I_{source}_{_{—}}_{avg}, and the phase of V_{source}_{_{—}}_{avg} is approximately equal to the phase of I_{source}_{_{—}}_{avg}.

Referring to FIGS. 3-5B, alternate embodiments of the power system 50 are contemplated. For example, the power supply 15 may be any type of switching power supply other than a buck converter. Furthermore, the determiner 52 may be controlled by other than the switching controller 26, and may be disposed in a circuit other than a power supply. Moreover, the integrating current Iᵢₙ_{_{—}}_{integrate} may be generated by any suitable circuit other than the current mirror 54. In addition, the calculation of V_{Iin} _{_{—}}_{avg} may be implemented in software or in firmware, such as by an instruction-executing processor, or in a combination or subcombination of software, firmware, and hardware. Furthermore, the stage 62 may be implemented in software or firmware, such as by an instruction-executing processor, or in a combination or subcombination of software, firmware, and hardware. Moreover, the above-described current-average determining technique may be used to determine the average of signals other than a power-supply input current. For example, the technique may be used in a battery charger to determine the average charging current being supplied to a battery; the charger may include a circuit for limiting the average charging current in response to this determination so as to prevent damage to the battery. In addition, the technique, or an embodiment thereof, may be used to determine a characteristic other than an average of a signal other than a current. Furthermore, one or more components of the power supply 14 and determiner 52 may be disposed on a power-supply controller, which may be an integrated circuit. In addition, one or more components of the power supply 14 and determiner 52 may be disposed in a power-supply module.

FIG. 6A is a time plot of the average source current I_{source}_{_{—}}_{avg} from the power source 12 of the power system 10 of FIG. 1 in response to a step increase in Iᵢₙ_{_{—}}_{avg}, where the power system is configured to limit I_{source}_{_{—}}_{avg} to a maximum threshold I_{Limit}, according to an embodiment.

FIG. 6B is a time plot of the average source current I_{source}_{_{—}}_{avg} from the power source 12 of the power system 50 of FIG. 3 in response to a step increase in Iᵢₙ_{_{—avg}}, where the power system is configured to limit I_{source}_{_{—}}_{avg} to I_{Limit}, according to an embodiment.

In the below-described example, I_{Limit}=2 A.

The ability of the power system 10 (FIG. 1) to limit I_{source}_{_{—}}_{avg} to I_{Limit} is now compared to the ability of the power system 50 (FIG. 3) to limit I_{source}_{_{—}}_{avg} to I_{Limit} in conjunction with FIGS. 1, 3, and 5B-6B. For example, the power systems 10 and 50 may limit I_{source}_{_{—}}_{avg} to prevent damage to the power source 12 (e.g., a battery). Because such current limiting, and the circuitry for performing such current limiting, is conventional, a detailed description of such current limiting and current-limiting circuitry is omitted for brevity.

Because, in a steady state, I_{source}_{_{—}}_{avg}=Iᵢₙ_{_{—}}_{avg}, a power system such as the power system 10 or 50, may limit I_{source}_{_{—}}_{avg} by monitoring and limiting Iᵢₙ_{_{—}}_{avg}.

As described above in conjunction with FIGS. 1 and 2, to determine Iᵢₙ_{_{—}}_{avg}, the power system 10 may include a sense resistor in series with Iᵢₙ, and a low-pass filter that filters the voltage across the sense resistor to generate a filtered voltage that is related to Iᵢₙ_{_{—}}_{avg}.

But as also described above, such a low-pass filter may cause a delay between Iᵢₙ and the filtered voltage; that is, the filtered voltage may lag the actual average Iᵢₙ_{_{—}}_{avg} of Iᵢₙ.

Referring to FIG. 6A, if this filtered voltage is used to monitor Iᵢₙ_{_{—}}_{avg}, and to limit Iᵢₙ_{_{—}}_{avg}, and, therefore, to limit I_{source}_{_{—}}_{avg}, to a limit threshold I_{Limit} in response to the monitored Iᵢₙ_{_{—}}_{avg}, then by the time that the filtered voltage indicates that Iᵢₙ_{_{—}}_{avg} has exceeded I_{Limit} and the limit circuitry can limit Iᵢₙ_{_{—}}_{avg} to I_{Limit}, I_{source}_{_{—}}_{avg} may have already exceeded the limit. In this example, I_{source}_{_{—}}_{avg} exceeds I_{Limit}=2 A from a time t₀, when the step increase in Iᵢₙ_{_{—}}_{avg} begins, to a time t₁, when the limit circuitry of the power system 10 finally is able to limit I_{source}_{_{—}}_{avg} to I_{Limit}. That is, the time between t₀ and t₁ is the lag time between the start of the step increase in Iᵢₙ_{_{—}}_{avg} and the limiting of I_{source}_{_{—}}_{avg} to I_{Limit} by the power system 10.

Unfortunately, this lag time between t₀ and t₁ may be long enough to allow the power source 12 to be damaged by an average source current I_{source}_{_{—}}_{avg} that is too high for too long.

In contrast, referring to FIG. 5B, because the determiner 52 of the power system 50 (FIG. 3) has no such lag time, V_{Iin}_{_{—}}_{avg}, which represents Iᵢₙ_{_{—}}_{avg}, leads V_{source}_{_{—}}_{avg}, which represents I_{source}_{_{—}}_{avg}, just as Iᵢₙ_{_{—}}_{avg} leads I_{source}_{_{—}}_{avg}.

Consequently, referring to FIG. 6B, when the power system 50 (FIG. 3) monitors V_{Iin}_{_{—}}_{avg} and limits V_{Iin}_{_{—}}_{avg} to I_{Limit} in response to V_{Iin}_{_{—}}_{avg} equaling or exceeding I_{Limit}, the power system 50 is able to limit I_{source}_{_{—}}_{avg} to I_{Limit} before I_{source}_{_{—}}_{avg} exceeds I_{Limit}.

FIG. 7 is a block diagram of an embodiment of a computer system 100, which incorporates the power system 50 (or only the power supply 14) of FIG. 3, according to an embodiment. Although the system 100 is described as a computer system, it may be any system for which an embodiment of the power system 50 (or only the power supply 14) is suited.

The system 100 includes computing circuitry 102, which, in addition to the supply system 50 (or only the supply 14) of FIG. 3, includes a processor 104 powered by the system (or only the supply), at least one input device 106, at least one output device 108, and at least one data-storage device 110.

In addition to processing data, the processor 104 may program or otherwise control the system 50 (or only the supply 14). For example, the functions of the power-supply controller 26 may be performed by the processor 104.

The input device (e.g., keyboard, mouse) 106 allows the providing of data, programming, and commands to the computing circuitry 102.

The output device (e.g., display, printer, speaker) 108 allows the computing circuitry 102 to provide data in a form perceivable by a human operator.

And the data-storage device (e.g., flash drive, hard disk drive, RAM, optical drive) 110 allows for the storage of, e.g., programs and data.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated. Moreover, the components described above may be disposed on a single or multiple IC dies to form one or more ICs, these one or more ICs may be coupled to one or more other ICs. In addition, any described component or operation may be implemented/performed in hardware, software, firmware, or a combination of any two or more of hardware, software, and firmware. Furthermore, one or more components of a described apparatus or system may have been omitted from the description for clarity or another reason. Moreover, one or more components of a described apparatus or system that have been included in the description may be omitted from the apparatus or system.

What is claimed is:

1. An apparatus, comprising:
a charging circuit configured to generate a charge on a capacitor with a first current that is related to a signal having a characteristic; and
a determining circuit configured to determine the characteristic of the signal in response to the charge on the capacitor.

2. The apparatus of claim 1, further comprising the capacitor.

3. The apparatus of claim 1 wherein the signal includes a power-supply input current.

4. The apparatus of claim 1 wherein the signal includes a current generated by a power source that provides power to a power supply.

5. The apparatus of claim 1, further comprising:
wherein the signal includes a second current; and
a mirror circuit configured to generate the first current in response to the second current.

6. The apparatus of claim 1 wherein the determining circuit is configured to determine the characteristic of the signal in response to a voltage across the capacitor.

7. The apparatus of claim 1, further comprising:
a filter configured to generate a filtered voltage in response to a voltage across the capacitor; and
wherein the determining circuit is configured to determine the characteristic of the signal in response to the filtered voltage.

8. The apparatus of claim 1 wherein the determining circuit is configured to determine that a magnitude of the characteristic of the signal is approximately equal to a magnitude of a voltage across the capacitor.

9. The apparatus of claim 1 wherein the characteristic includes an average.

10. A power supply, comprising:
a capacitor;
a charging circuit configured to generate a charge on the capacitor with a first current that is related to a signal that has a characteristic; and
a determining circuit configured to determine the characteristic of the signal in response to the charge on the capacitor.

11. The power supply of claim 10, further comprising:
wherein the signal includes a second current; and
an inductor configured to conduct the second current.

12. The power supply of claim 10, further comprising:
wherein the signal includes a second current; and
an input node configured to receive the second current.

13. The power supply of claim 10, further comprising:
wherein the signal includes a second current; and
an input node configured to receive a current that is related to the second current.

14. A system, comprising:
a power supply, including
a capacitor,
a charging circuit configured to generate a charge on the capacitor with a first current that is related to a signal that has a characteristic, and
a determining circuit configured to determine the characteristic of the signal in response to the charge on the capacitor; and
a load coupled to the power supply.

15. The system of claim 14, further comprising:
wherein the power supply includes an input node;
wherein the signal includes a second current; and
a power source configured to provide the second current to the input node.

16. The system of claim 14, further comprising:
wherein the power supply includes an input node;
wherein the signal includes a second current; and
a power source configured to provide a third current to the input node, the third current being related to the second current.

17. The system of claim 14 wherein the power supply includes a buck converter.

18. A method, comprising:
generating a charge on a capacitor with a first current that is related to a signal having a characteristic; and
determining the characteristic of the signal in response to the charge on the capacitor.

19. The method of claim 18, further comprising:
wherein the signal includes a second current; and
providing the second current to a power supply.

20. The method of claim 18, further comprising:
wherein the signal includes a second current; and
generating the second current with a power source.

21. The method of claim 18, further comprising determining the characteristic of the signal in response to a voltage across the capacitor.

22. A power-supply controller, comprising:
a charging circuit configured to generate a charge on a capacitor with a first current that is related to a signal having a characteristic; and
a determining circuit configured to determine the characteristic of the signal in response to the charge on the capacitor.
